(19) United States
(12) Patent Application Publication
(10) Pub. No.: US 2026/0362172 A1
(43) Pub. Date: Nov. 12, 2026

(54) METHODS AND SYSTEM FOR RESELECTION OPTIMIZATION FOR MINIMIZATION OF SERVICE INTERRUPTION

(71) Applicant: INTERDIGITAL PATENT HOLDINGS, INC., Wilmington, DE (US)

(72) Inventors: Anuj Sethi, Montreal (CA); Jaya Rao, Montreal (CA); Michael Starsinic, Newtown, PA (US); Taimoor Abbas, Sainte-Julie (CA)

(73) Assignee: INTERDIGITAL PATENT HOLDINGS, INC., Wilmington, DE (US)

(21) Appl. No.: 19/201,682

(22) Filed: May 7, 2025

(51) Int. Cl. H04W 24/04; H04W 36/08; H04W 36/30; H04W 84/04

(52) U.S. Cl. CPC H04W 24/04; H04W 36/08; H04W 36/305; H04W 84/042

(57) ABSTRACT

A wireless transmit/receive unit (WTRU) is configured to manage mobility during disaster conditions affecting a fifth-generation (5G) public land mobile network (PLMN). Upon detecting that the 5G PLMN is impacted, the WTRU receives system information from a corresponding fourth-generation (4G) PLMN indicating support for disaster roaming. The WTRU camps on the 4G cell and registers for service. To avoid service disruption due to frequent reselection near the disaster boundary, the WTRU applies reselection restriction mechanisms, including deprioritizing 5G cells, ignoring system information about 5G neighbors, adjusting reselection timers and thresholds, and skipping 5G frequency scans. These mechanisms allow the WTRU to remain on the 4G network until the disaster condition ends, after which the WTRU may safely return to 5G service. The invention enhances connectivity resilience and ensures stable user experience across mixed-generation networks during emergency scenarios.

### BACKGROUND

Wireless communication devices may be configured to operate within a variety of public land mobile networks (PLMNs). To support seamless connectivity, especially in scenarios involving service disruptions, such devices can be provisioned with information identifying networks that are to be treated as equivalent. This allows the device to regard multiple networks or access technologies as interchangeable for purposes such as registration, cell selection, and reselection. For example, in situations where a disaster affects 5G services (5GS), a PLMN may provide both disaster roaming in an Evolved Packet System (EPS, i.e., 4G) and normal 5G coverage. In such cases, the ability of the device to recognize functional equivalence between 4G and 5G layers of the same PLMN may impact its ability to maintain or restore service.

In particular, scenarios may arise where a device initially registered on a 5G network (e.g., PLMN-D/5G) experiences disaster-related service degradation, reselects the same PLMN using a 4G access technology (PLMN-D/4G), and successfully registers for continued service. As the device moves near the boundary of the affected area, there is a risk of frequent reselection or “ping-ponging” between the normal 5G service and the disaster-mode 4G service, potentially leading to service disruption and degraded user experience. Accordingly, there is a need for improved mechanisms to manage network selection and reselection behavior in mixed-service scenarios, particularly in the context of disaster recovery and multi-access technology environments.

### SUMMARY

Techniques for improving network selection behavior by a wireless transmit/receive unit (WTRU) during disaster conditions are disclosed. Particularly, techniques are disclosed for when both fifth-generation (5G) and fourth-generation (4G) access networks are operated under the same public land mobile network (PLMN). In one aspect, a method is disclosed in which the WTRU initially registers with a 5G access network (e.g., PLMN-D/5G). Upon detecting that the 5G network is impacted by a disaster condition, the WTRU transitions to a corresponding 4G network (PLMN-D/4G) that is configured to provide disaster roaming services. This transition is facilitated through system information broadcast by the 4G cell, which includes an indication of the disaster condition and a list of affected PLMN identifiers. Once camped on the 4G cell, the WTRU may register for disaster roaming services.

To maintain service continuity and avoid instability near the edge of the disaster zone, the WTRU employs one or more cell reselection mechanisms to suppress reselection back to the 5G network while the disaster condition remains in effect. These mechanisms may include ignoring system information block 24 (SIB24), which contains details of neighboring 5G cells; assigning the highest reselection priority to the 4G cell; overriding default reselection timers to delay unnecessary transitions; and skipping specific 5G frequencies or ARFCNs during cell search. The WTRU may also apply alternative signal quality thresholds or offset values to deprioritize 5G cells, treat certain 5G cells as barred based on master information block (MIB) or SIB1 indications, and respond to paging signals that include updated reselection parameters. These paging messages may further trigger the WTRU to request additional system information defining disaster-aware reselection criteria.

Once the disaster condition is determined to have ended—based on network broadcasts or dedicated signaling—the WTRU may safely reselect and return to a 5G cell in PLMN-D/5G. The techniques described herein can be implemented as a method or embodied in a WTRU device comprising a processor and transceiver configured to carry out the operations. These enhancements enable improved mobility handling, reduced service disruption, and more resilient disaster recovery behavior across multi-RAT PLMN deployments.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example coverage map where a WTRU is moving along the edge of a disaster area;

FIG. 3 is an example procedure for a WTRU to reselect to a 4G PLMN when a disaster condition is detected on a 5G PLMN; and

FIG. 4 is an example WTRU based procedure for reselecting to 4G PLMN when a disaster condition is detected on a 5G PLMN.

### DETAILED DESCRIPTION

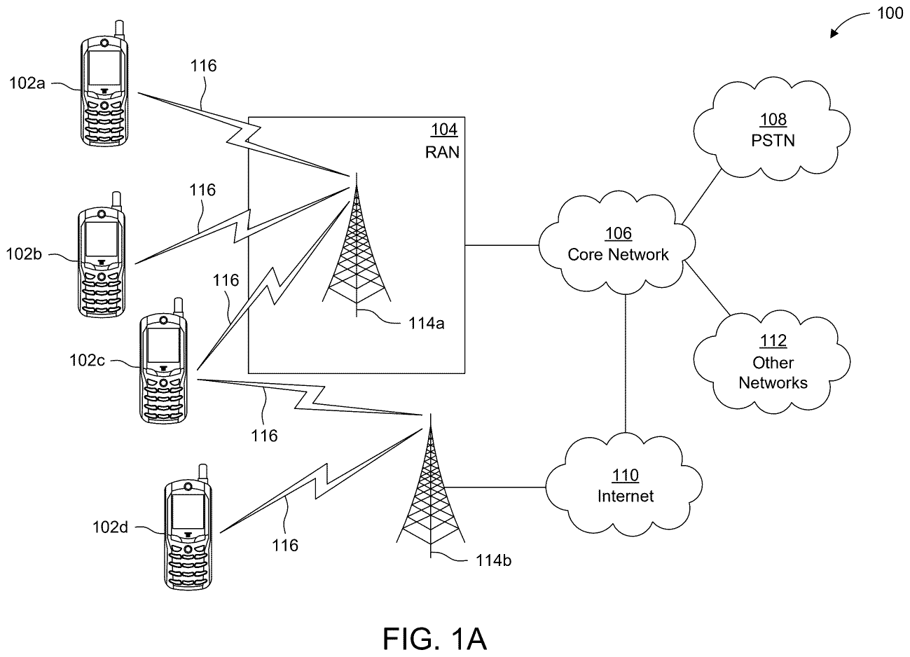

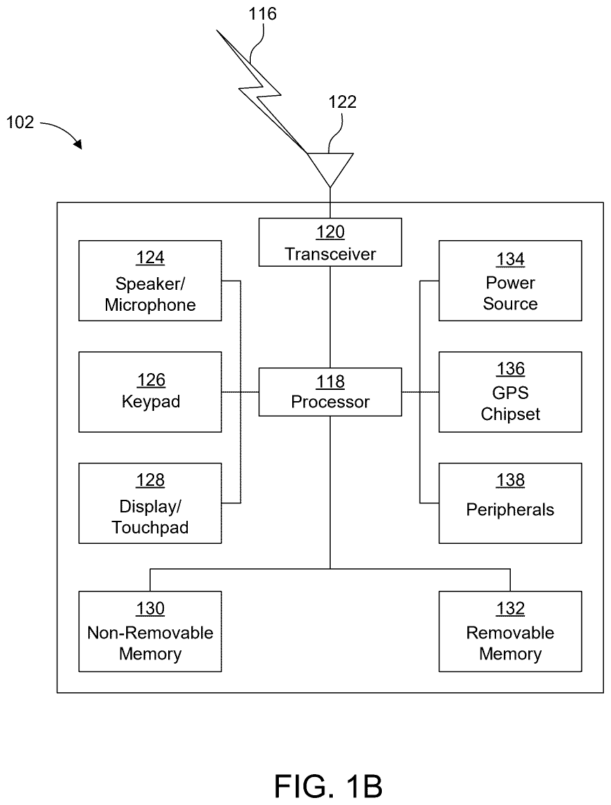

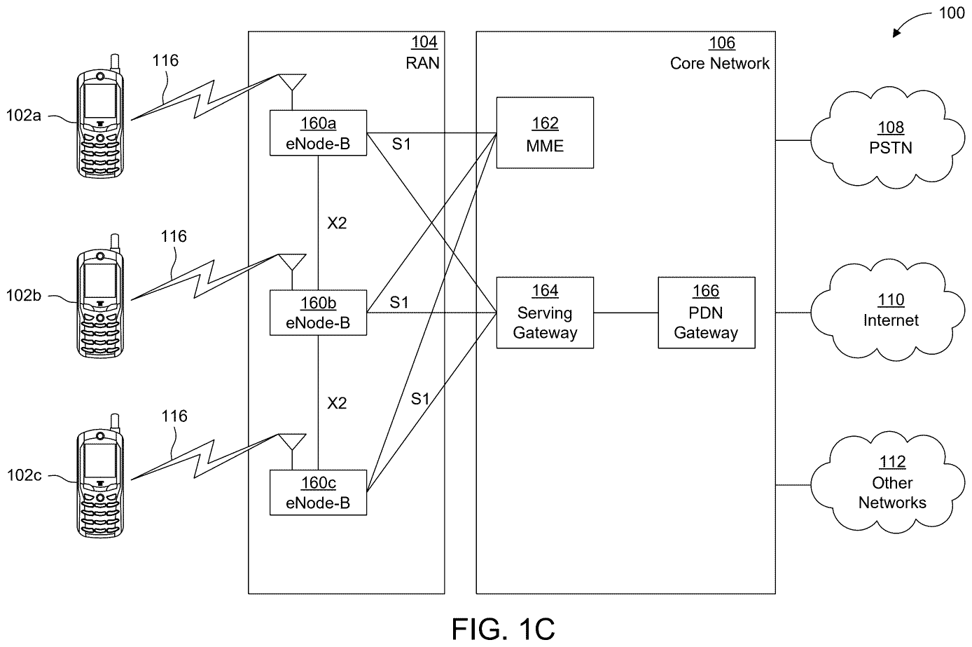

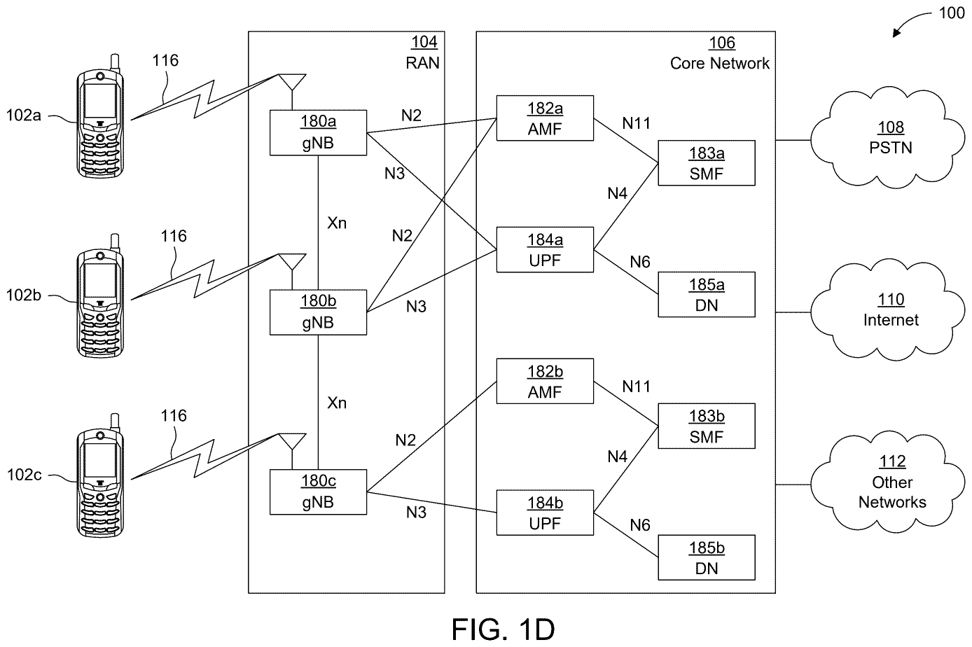

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Access Technology used herein includes access technology associated with a PLMN or SNPN. The MS uses this information to determine what type(s) of radio carrier to search for when attempting to select a specific PLMN or SNPN. The following access technologies are defined: GSM, UTRAN, GSM COMPACT, EC-GSM-IoT, cdma2000 1xRTT, cdma2000 HRPD, E-UTRAN (WB-S1 mode and NB-S1 mode), NG-RAN, satellite NG-RAN and satellite E-UTRAN (WB-S1 mode and NB-S1 mode). A PLMN may support more than one access technology. SNPNs only support NG-RAN.

In the case of an MS operating in MS operation mode A or B, allowable PLMN is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

In the case of an MS operating in SNPN access operation mode over 3GPP access and for an SNPN candidate which is not an SNPN selected for localized services in SNPN, an Allowable SNPN is an SNPN which is not in the list of “permanently forbidden SNPNs” which is, if the MS supports access to an SNPN using credentials from a credentials holder, equivalent SNPNs or both, associated with the selected entry of the “list of subscriber data” or the selected PLMN subscription, and is not in the list of “temporarily forbidden SNPNs” which is, if the MS supports access to an SNPN using credentials from a credentials holder, equivalent SNPNs or both, associated with the selected entry of the “list of subscriber data” or the selected PLMN subscription. In the case of an MS operating in SNPN access mode and for an SNPN candidate which is an SNPN selected for localized services in SNPN, this is an SNPN which is not in the list of “permanently forbidden SNPNs for access for localized services in SNPN” which is associated with the selected entry of the “list of subscriber data” or the selected PLMN subscription, and is not in the list of “temporarily forbidden SNPNs for access for localized services in SNPN” which is associated with the selected entry of the “list of subscriber data” or the selected PLMN subscription.

An allowable PLMN/access technology combination is defined as follows. For a MS operating in MS operation mode C, or for an MS that does not support A/Gb mode and does not support Iu mode, any PLMN in any specific access technology is considered allowable. For an MS operating in MS operation mode A or B, a PLMN/access technology combination is considered allowable if either (i) the PLMN is an allowable PLMN and the specific access technology supports non-GPRS services, or (ii) the PLMN is not listed in the MS's list of forbidden PLMNs or forbidden PLMNs for GPRS service, and the specific access technology supports only GPRS services.

Camped on a cell refers to a state in which the MS, or the mobile equipment (ME) if there is no SIM, has completed the cell selection or reselection process and has selected a cell from which it intends to receive all available services. The services available may be limited, and the public land mobile network (PLMN) or the standalone non-public network (SNPN) may not be aware of the presence of the MS or ME within the selected cell.

A Current serving cell is a cell on which the MS is camped.

A Home PLMN This is a PLMN where the MCC and MNC of the PLMN identity match the MCC and MNC of the IMSI.

A visited PLMN is a PLMN different from the HPLMN (if the EHPLMN list is not present or is empty) or different from an EHPLMN (if the EHPLMN list is present).

In A/Gb mode refers to operation within a GSM system that uses the A/Gb interface. In cases where multiple systems are supported, the mode is determined by the current serving radio access network.

In Iu mode refers to operation within a UMTS system. In cases where multiple systems are supported, the mode is determined by the current serving radio access network.

In S1 mode refers to operation within an Evolved Packet System (EPS). The S1 mode encompasses both wideband S1 mode (WB-S1) and narrowband S1 mode (NB-S1). In cases where multiple systems are supported, the mode is determined by the current serving radio access network.

In N1 mode refers to operation within a 5G System (5GS). In cases where multiple systems are supported, the mode is determined by the current serving radio access network.

Registered PLMN (RPLMN) is the public land mobile network on which certain location registration (LR) outcomes have occurred, as described in TS 23.122. In a shared network, the RPLMN is identified by the core network (CN) operator that has accepted the location registration, as indicated by the PLMN identity.

Registration is the process by which a mobile station camps on a cell of a PLMN or standalone non-public network (SNPN) and performs any necessary location registrations.

Selected PLMN refers to the PLMN that has been selected either manually by the user or automatically by the device, in accordance with the procedures set forth in TS 23.122.

Steering of Roaming (SOR) is a technique used to influence a roaming user equipment (UE) to connect to a preferred visited network, as indicated by the home PLMN (HPLMN).

Steering of Roaming Application Function (SOR-AF) is an application function that may provide a Unified Data Management (UDM) entity with one of the following: (a) one or more of the following elements: a list of preferred PLMN/access technology combinations; a Steering of Roaming control model configuration information (SOR-CMCI), optionally accompanied by a “Store SOR-CMCI in ME” indicator; a SOR standalone non-public network selection indication (SOR-SNPN-SI); and a SOR standalone non-public network selection indication list (SOR-SNPN-SI-LS); (b) a secured packet, which may include an indicator that the list of preferred PLMN/access technology combinations is not included in the secured packet; or (c) none of the above, where the information is generated dynamically based on operator-specific data analytics.

RAN Node, Base Station, eNodeB, and gNodeB are used interchangeably to refer to the radio access network equipment serving the UE.

PLMN with Disaster Condition refers to a PLMN that is subject to a declared disaster condition. For example, PLMN-D/5G refers to the 5G base station(s) of PLMN-D under a disaster condition.

PLMN without Disaster Condition refers to a PLMN that is not currently affected by any disaster condition. Examples include PLMN-A, PLMN-X, or PLMN-D/4G when not under such condition.

PLMN Supporting Disaster Inbound Roaming refers to a PLMN, such as PLMN-A, that allows inbound roaming from a PLMN experiencing a disaster condition, such as PLMN-D/5G or PLMN-D/4G.

PLMN-D/5G denotes the 5G base station(s) of the PLMN identified as PLMN-D.

PLMN-D/4G denotes the 4G base station(s) of the PLMN identified as PLMN-D.

PLMN-A denotes the PLMN identified by the name PLMN-A.

Network selection is the process by which a wireless transmit/receive unit (WTRU) performs a radio scan to determine the availability of public land mobile networks (PLMNs) at its current location and attempts to register with a PLMN in accordance with the 3GPP defined standards. Upon power-on or after regaining coverage following a period of no service, the WTRU selects the PLMN with which it was last registered, if that PLMN is available, and attempts to perform a registration using the last registered access technology. If the previously registered PLMN is not available, the WTRU scans all radio frequency channels across all supported frequency bands and access technologies within its capabilities to detect available PLMNs. For each carrier, the WTRU identifies the strongest cell and reads its system information in order to determine the associated PLMN.

If there is no last registered PLMN or if registration with that PLMN is not possible due to unavailability or registration failure, the WTRU proceeds according to the procedures specified in 3GPP standards, based on whether the network selection mode is automatic or manual.

The WTRU follows a defined priority order when selecting and attempting to register with a PLMN/access technology combination. First, the WTRU attempts to register with either the home PLMN (HPLMN) if no equivalent HPLMN (EHPLMN) list is present or populated, or with the highest-priority EHPLMN if such a list exists and is populated. Next, the WTRU attempts registration with each PLMN/access technology combination listed in the “User Controlled PLMN Selector with Access Technology” data file stored on the SIM, following the order of priority specified therein. If none of these are available, the WTRU proceeds to attempt registration with each PLMN/access technology combination in the “Operator Controlled PLMN Selector with Access Technology” data file, either from the SIM or from the mobile equipment (ME), again following the defined priority order. Finally, if no suitable match is found in any of these lists, the WTRU may attempt to register with other PLMN/access technology combinations that are detected with high signal quality, in a random order.

A wireless transmit/receive unit (WTRU) may be configured with a list of equivalent public land mobile networks (PLMNs). The networks included in this list are treated by the WTRU as equivalent for the purposes of PLMN selection and cell selection or reselection. Configuration of the WTRU with such a list typically involves the network transmitting the list to the WTRU, which then stores it in memory. For example, the list may be received during a registration procedure and retained for future use.

The list of equivalent PLMNs comprises multiple PLMN identifiers, each of which includes at least a mobile country code (MCC) and a mobile network code (MNC). In some cases, a PLMN identifier may also be derived from the WTRU's subscription information, such as from a subscriber permanent identifier (SUPI). For instance, an international mobile subscriber identity (IMSI), which is a type of SUPI, may contain a PLMN identifier that corresponds to the WTRU's home network.

In addition to the general list of equivalent PLMNs, the WTRU may also be configured with a list of equivalent home PLMNs (HPLMN). This list similarly comprises PLMN identifiers, and the WTRU treats the PLMNs in this list as interchangeable for PLMN selection and cell selection or reselection purposes.

Minimization of service interruption (MINT) is a feature that enables a WTRU of a selected PLMN (PLMN D) with disaster condition (e.g., one or more NG-RAN nodes down), to select and register to another PLMN (PLMN A) without disaster condition when no other PLMN is available and PLMN A accepts disaster Inbound roamers from PLMN D. 3GPP standards have specified that 3GPP systems shall be able to support a WTRU, with only 5G national roaming access to a VPLMN, to obtain 4G connectivity service from that VPLMN in the area where a disaster condition exists.

In this scenario, the WTRU still receives service from IMS (voice service) in HPLMN and only connectivity from VPLMN. This requirement allows 5G-only national roaming WTRUs to register for disaster roaming service in EPS of the same VPLMN. As a result, the 4G system shall be able to provide disaster roaming service. It is valuable to further evaluate and provide solutions to fulfil the above 3GPP requirement.

Additionally, it could be a valid network deployment that the operator deploys 5G system and 4G system with different PLMN IDs to ensure that 5G-only national roaming WTRUs cannot access 4G in normal conditions. When the network's 5G RAN is in the disaster condition and it's 4G network provides disaster roaming service, 5G-only national roaming WTRUs can select the 4G network from the forbidden PLMN list to register for disaster roaming service.

Enhancements to the 5G system, are proposed herein, to handle the scenario whereby a WTRU which is successfully registered on the PLMN-D/5G goes under the disaster on 5G, reselects the same PLMN i.e. PLMN-D on the 4G access technology and successfully registers with PLMN-D/4G. While the WTRU is successfully camped on the PLMN-D/4G, moving along the edge of the disaster area. More explicitly, embodiments herein address how a WTRU can be configured to avoid the ping-pong/frequent reselection between the PLMN-D/5G providing the normal service and PLMN-D/4G providing the disaster service thus resulting in service disruption and degraded user experience. Various mechanisms are proposed herein to ensure that the WTRU stays on the PLMN-D/4G cell while the disaster is ongoing, and the WTRU is moving along the edge of the disaster area. Similarly, mechanisms are proposed for the WTRU to (re)camp and move to a 5G cell in PLMN-D/5G (e.g. how to exit a 4G cell and move to a 5G cell). Any criteria (e.g. conditions, thresholds) associated with the mechanisms to re-camp on a 5G cell or mechanism to stay in the 4G cell may be predefined/preconfigured or received by the WTRU via broadcast (e.g. SIB) or dedicated signaling (e.g. RRC) from the other cells.

Cell selection and reselection improvements for a WTRU in disaster roaming service are described herein.

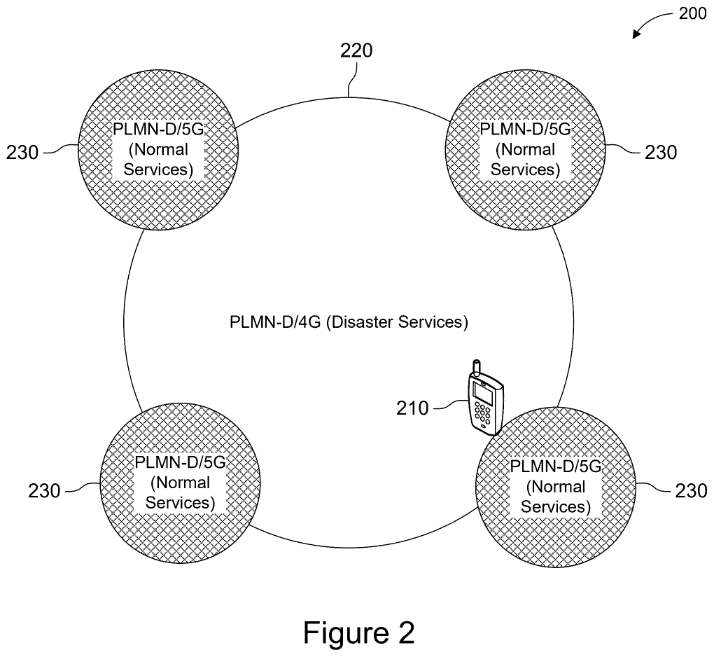

FIG. 2 is an example coverage map 200 wherein a WTRU 210 is moving along the edge of a disaster area 220 and in some areas, there is a coverage of the PLMN-D/5G 230 providing access to normal service, however this coverage is not uniform and consistent along the edge of the disaster area.

As the WTRU moves along the edge of the disaster zone, it may repeatedly detect and attempt to reselect between PLMN-D/4G and the surrounding PLMN-D/5G cells. This frequent reselection, or “ping-ponging,” between access technologies within the same PLMN can lead to unnecessary registration attempts, increased signaling load, service interruptions, and overall degraded user experience. All of these issues may be further exacerbated in the case where there are a lot of WTRUs attempting to make a similar reselection. To mitigate this, the WTRU should be configured to recognize the operational context and refrain from unnecessary transitions between PLMN-D/4G and PLMN-D/5G, particularly when disaster recovery procedures are active.

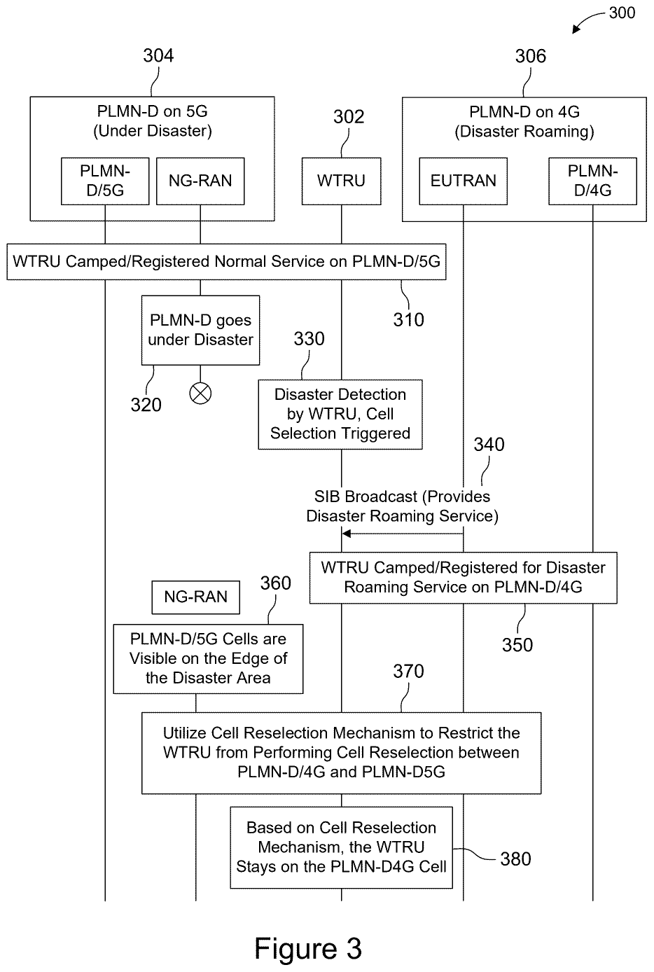

FIG. 3 illustrates an example procedure 300 of the WTRU 302 which is successfully registered on the PLMN-D/5G 304 goes under the disaster on 5G, reselects the same PLMN i.e. PLMN-D on the 4G access technology and successfully registers with PLMN-D/4G 306. While the WTRU 302 is successfully camped on the PLMN-D/4G 306, moving along the edge of the disaster area the WTRU 302 is able to avoid a ping-pong/frequent reselection between the PLMN-D/5G 304 providing the normal service and PLMN-D/4G 306 providing the disaster service thus resulting in service disruption and degraded user experience.

At 310, the WTRU 302 performs the registration procedure on the 5G mobile network, PLMN-D/5G 304. The registration procedure in 5GS could be an initial registration, mobility, or periodic registration procedure. The WTRU 302 supports the 3GPP feature the Minimization of service interruption (MINT). At 310, PLMN-D/5G 304 is not in a disaster condition.

At 320, the serving network goes under disaster i.e. disaster conditions now apply to the PLMN-D/5G 304.

At 330, Step 3—the WTRU 302 detects that the PLMN-D/5G 304 is under disaster conditions, this detection may happen via various means of determination e.g.,

In one example, the PLMN-D/4G 306 or PLMN-A (a PLMN which is not in a disaster condition) cell may broadcast an indication about the disaster condition. In an example, a WTRU 302 may detect one or more cells associated with PLMN-D/5G 304 that are under disaster conditions based on the reception of system information broadcast (SIB) or other indications (e.g. RRC messages) from other cells that may indicate the disaster condition. Such cells accessible by the WTRU 302 (e.g. SSBs, SIB1 and other signals/channels of the cells are accessible by the WTRU 302) may include any of a 4G or 5G cell that is not subject to a disaster condition

In another example, the PLMN-D/5G 304 may reject the registration procedure with reject cause indicating disaster condition. In an example, the WTRU 302 may camp on the cell (e.g. SSBs and SIB1 of the cell are accessible) and the WTRU 302 may initiate initial access procedure in IDLE mode. However, the WTRU 302 may receive a RRC setup failure message (e.g. in Msg4), possibly with the rejection cause indicating the cell is undergoing disaster condition.

In another example, PLMN-A cell (not shown) may broadcast information including the PLMN ID or a list of PLMN IDs that are subject to the disaster i.e., including PLMN-D/5G 304 or PLMN-X cell broadcast information including the PLMN ID or a list of PLMN IDs that are subject to the disaster i.e., including PLMN-D/5G 304.

At 340, the WTRU 302 receives/monitors the system information broadcast from the PLMN-D/4G cell 306, which broadcasts an indication that the PLMN-D/4G 306 provides disaster roaming services and the cell broadcast the list of PLMN IDs which are under disaster for which it is providing the disaster roaming service. The list of PLMN IDs include the PLMN ID of the PLMN-D/5G 304 which is under disaster. In another example, the WTRU may receive the list of cell IDs (e.g. PCIs), possibly associated with PLMN-D/5G 304 or other PLMNs that are not accessible (e.g. undergoing disaster condition) and accessible (e.g. partially accessible with limited services or fully accessible with normal services).

It should be noted that at 304, the 4G (i.e. E-UTRA) cell may broadcast an indication that the cell is associated with PLMN-D, broadcast an indication that PLMN-D is under disaster condition, and broadcast No indication that the 4G cell is under disaster condition. Alternatively, the 4G cell may broadcast an explicit indication that the 4G cell is NOT under a disaster condition.

At 350, the WTRU 302 camps on the PLMN-D/4G 306 and successfully registers itself for the disaster roaming services. The registration message from the WTRU 302 may explicitly indicate that the registration type is disaster roaming services. For example, a WTRU in IDLE mode may register with a cell associated with PLMN-D/4G 306 upon successfully performing initial access procedure (e.g. RACH procedure) on the cell.

At 360, the WTRU 302 is moving along the edge of the disaster area and in some areas, there is a coverage of the PLMN-D/5G 304 providing access to normal service, however this coverage is not uniform and consistent along the edge of the disaster area. This coverage map is illustrated and described with respect to FIG. 2.

At 370, the WTRU 302, while camped on the PLMN-D/4 G 306 cell registered for disaster roaming services and while disaster is still active shall optimize the cell reselections to ensure it does not end up performing frequent reselections to cells associated with PLMN-D/5G around the edge of the disaster area resulting in frequent service disruptions and degraded user experience. Possible mechanisms to optimize/restrict cell (re) selection for the WTRU 302 to any cells associated with PLMN-D/5G while the disaster is ongoing are proposed, and considered below in two possible categories: (1) mechanisms for the WTRU 302 to stay with a 4G cell in PLMN-D/4G 306 (e.g. how the WTRU refrains from initiating cell (re)selection to a 5G cell in PLMN-D/5G); and (2) mechanisms for the UE to (re)camp and move to a 5G cell in PLMN-D/5G (e.g. how to exit a 4G cell and move to a 5G cell).

At 380, based on the optimized cell (re)selection procedure of 370, the WTRU 302 decides to stay camped on PLMN-D/4G (i.e. the E-UTRA cell of PLMN-D).

Example mechanisms for the WTRU 302 to stay with a 4G cell in PLMN-D/4G 306 (e.g. how the WTRU refrains from initiating cell (re)selection to a 5G cell in PLMN-D/5G) are proposed herein. Any criteria (e.g. conditions, thresholds) associated with the mechanisms to stay on 4G cell may be predefined/preconfigured or received by the WTRU via broadcast (e.g. SIB) or dedicated signaling (e.g. RRC) from the other cells.

In scenarios where the WTRU 302 is camped on a 4G cell associated with PLMN-D/4G 306 that is providing disaster roaming services, and where PLMN-D/5G 304 remains impacted by a disaster, the WTRU may be configured to refrain from initiating cell selection or reselection to 5G cells in PLMN-D/5G 304. Various mechanisms may be employed to support this behavior and mitigate the risk of unnecessary reselection that could degrade service continuity and user experience.

In one example, the WTRU may ignore information broadcast by the 4G cell that would otherwise be used to support idle mode reselection to 5G cells. For instance, the WTRU 302 may ignore or skip SIB24 for cell (re)selection on a 5G cell. SIB24 provides information to the WTRU on when and how to reselect an NR Cell, and is broadcasted by an LTE Cell (PLMN-D/4G). SIB24 is broadcasted by the LTE eNB and provides the WTRU with information about the 5G neighboring cells (e.g. NR Absolute Radio Frequency Channel Number (ARFCN), Cell Reselection priorities per NR Cell, frequency band information, threshold for signal strength and quality etc.) to enable cell reselection to the 5G cell in the idle mode. The WTRU while the disaster is ongoing, i.e. the camped PLMN-D/4G is broadcasting disaster-related indication, should ignore the contents of the SIB24 and this will ensure that it does not carry out unnecessary reselection to the PLMN-D/5G cell or its equivalent PLMNs in the 5G access technology. For example, if SIB24 is transmitted by a cell on an on-demand basis, the WTRU may refrain from sending a request for SIB24 to the cell upon receiving the disaster-related indication. For example, the WTRU may ignore the information from SIB24 when the WTRU determines that a disaster condition is ongoing. For example, the WTRU may use the information from SIB24 only when the WTRU determines that there is no disaster condition.

In another example, the WTRU may adjust the relative cell reselection priority of the 4G cell. In this example, the WTRU while disaster is ongoing, i.e. camped PLMN-D/4G that is broadcasting disaster related indication, could mark the priority of the camped LTE cell as the highest, this will ensure reselection based on cell reselection priority as per the SIB24 can be avoided, as the LTE cell would have the highest priority with respect to the NR neighboring cells.

In another example, the WTRU may adjust the Treselection duration, commonly referred to as the Treselection timer. In this example the WTRU may override the default Treselection duration with an extended value such that reselection to another cell—such as a 5G neighbor—is triggered only under exceptional circumstances (e.g., when the signal strength of the serving 4G cell drops below a predefined threshold or when uplink/downlink transmissions involving critical data are ongoing).

In another example, the WTRU may be configured or indicated (e.g. via SIB1, SIB15 or a new SIBx) to skip the sync raster/ARFCN frequency locations associated with the SSBs of 5G cells in PLMN-D. For example, the WTRU may receive an indication on whether to skip or not skip (i.e. monitor) the frequency locations of 5G cells in a new or an existing information element (IE) corresponding to a SIB received from the 4G cells. One or more reserve bits in an IE of a SIB (e.g. SIB15) may indicate to skip monitoring the frequency locations of 5G cell, for example. Such indication in SIB may be updated based on the SI modification period that may range from 640 ms to 10240 ms. In this case, the WTRU may monitor the corresponding SIB periodically (e.g. every 640 ms) to determine whether or not to skip the frequency locations of 5G cell. Such approach may be applied for making the related 5G cells to be temporarily ‘invisible’ during cell search while the WTRU is camped on the PLMN-D/4G cell (E-UTRA cell) which is providing the disaster roaming services. This behavior is applicable while the disaster conditions are true i.e., PLMN-D/5G is still under disaster and PLMN-D/4G is providing the disaster inbound roaming services.

In another example, the WTRU may update cell (re)selection threshold values. In this example, the WTRU may be configured with alternative cell (re)selection threshold values or offset values (e.g. RSRP/RSRQ/SINR thresholds or offsets) that may be applied when the WTRU may be located at the cell border area or under coverage of a 5G cell. For example, the WTRU may switch from a first set of RSRP thresholds (e.g. Th_1) to a second set of RSRP thresholds (e.g. Th_2) upon receiving a disaster-related indication, where the second set of RSRP threshold values may be higher than the first set of RSRP threshold values. Similarly, the WTRU may apply a set offset values to the cell reselection RSRP/SINR thresholds (e.g. Th_1+RSRPOffset) upon receiving a disaster-related indication. Such approaches may enable prolonging the WTRU to camp under the 4G cell and prevent from doing initial access on 5G cell.

In another example, a cell barring indication may be used. The WTRU may be barred from accessing the 5G cells located outside of disaster zone based on a cell barring indication set in the MIB or SIB1 of the 5G cells. The WTRU may check the status of cell barring info in the MIB or SIB1 based on the configured SI modification periodicity (e.g. 80 ms to 10.24 seconds).

In another example, reception of a paging indication may be used to indicate the disaster condition impacting the 5G cells and/or to restrict the WTRU from performing cell (re)selection away from the 4G PLMN-D. In this example, the WTRU may receive paging indication from 4G or 5G cells that may provide the conditions/thresholds for refraining from temporarily camping on 5G cells. Such conditions/thresholds (e.g. new priority, new thresholds, new reselection timer duration) may be provided in a PDSCH associated with a paging indication or in other messages upon triggering RACH with the paging indication. For example, the WTRU may receive a paging indication in a DCI which may contain an ID associated with the WTRU (e.g. P-RNTI or new RNTI). The WTRU may initiate the RACH procedure (e.g. transmit a PRACH preamble) upon receiving the paging indication. The WTRU may receive in PDSCH the conditions/thresholds for refraining from camping on 5G cells during the RACH procedure (e.g. in Msg4) or after the RACH procedure (e.g. in RRC (re)configuration messages). In another example, the WTRU may receive a paging indication containing one or more bits that may indicate the disaster condition and/or an index/id to a preconfigured set of conditions/threshold for refraining from camping on 5G cells. Alternatively, the WTRU may be triggered to send an on-demand request for other SI (e.g. SIB15, SIB24, or SIBx containing the conditions/thresholds) upon receiving the paging indication.

Collectively, these mechanisms allow the WTRU to remain camped on the PLMN-D/4G cell while disaster conditions persist and prevent premature or unnecessary transition to PLMN-D/5G. When the disaster condition affecting PLMN-D/5G is resolved, the WTRU may then safely reselect and recamp on a 5G cell, based on predefined or dynamically provided criteria, such as broadcast system information or dedicated signaling.

The following examples propose mechanisms for the WTRU to (re)camp and move to a 5G cell in PLMN-D/5G (e.g. how to exit a 4G cell and move to a 5G cell). Such mechanisms may be applied when the disaster conditions impacting the 5G cell ends and the WTRU may safely exist the 4G cell and move to the 5G cells. Any criteria (e.g. conditions, thresholds) associated with the mechanisms to re-camp on a 5G cell may be predefined/preconfigured or received by the WTRU via broadcast (e.g. SIB) or dedicated signaling (e.g. RRC) from the other cells.

In one example, the WTRU may (re)camp or move to 5G cell in a PLMN-D/5G upon reception of indications to enter a 5G cell. A WTRU may receive explicit or implicit indications (e.g. via SIB update, paging) indicating an update to the status of 5G cells (e.g. end/termination of disaster condition). Upon receiving such indications, the WTRU may update any conditions/thresholds (e.g. priority, RSRP thresholds) used for refraining from camping on the 5G cells. The WTRU may switch back to the previous conditions/threshold or use newly indicated conditions/threshold for camping on the 5G cells (e.g. perform initial access, handover, etc.).

In another example, the WTRU may (re)camp or move to 5G cell in a PLMN-D/5G upon expiration of a time period associated with disaster conditions. The configuration information on the timer (e.g. start offset and timer duration in terms of a number of SFNs, slots, symbols or ms) may be preconfigured or received by the WTRU via the SIBs (e.g. SIB15, SIB24 or new SIB) from 4G or 5G cells indicating the disaster condition. The WTRU may start the timer immediately or within k symbols/slots upon receiving an indication (e.g. in SIB, paging indication, Msg4) on the disaster condition impacting the 5G cells. A WTRU may maintain and monitor a timer associated with the disaster condition impacting the 5G cells. Upon expiry of the timer the WTRU may switch back to the previous mechanisms/assumptions for camping on the 5G cells. In an example, if the WTRU receives an indication indicating the end of disaster condition while the timer is running, the WTRU may stop and/or reset the timer. It should be noted that other devices may be used for measuring the timer period such as a clock, counter, or any other device capable of measuring a period of time.

In another example, the WTRU may (re)camp or move to 5G cell in a PLMN-D/5G based on measurements of signals/channels of 4G/5G cells. A WTRU may perform periodic L1/L3 measurements on the SSBs/RS received from the 4G cell and 5G cells in coverage. The WTRU may camp to 5G cell if any of the following conditions apply: RSRP/SINR measurements of the 4G cell drops below a threshold and stays below the threshold for a certain period; RSRP/SINR measurements of a 5G cell increases above a threshold and stays above the threshold for a certain period; and/or certain amount of time (e.g. T seconds) as elapsed since the reception of an indication on 5G cells undergoing disaster condition.

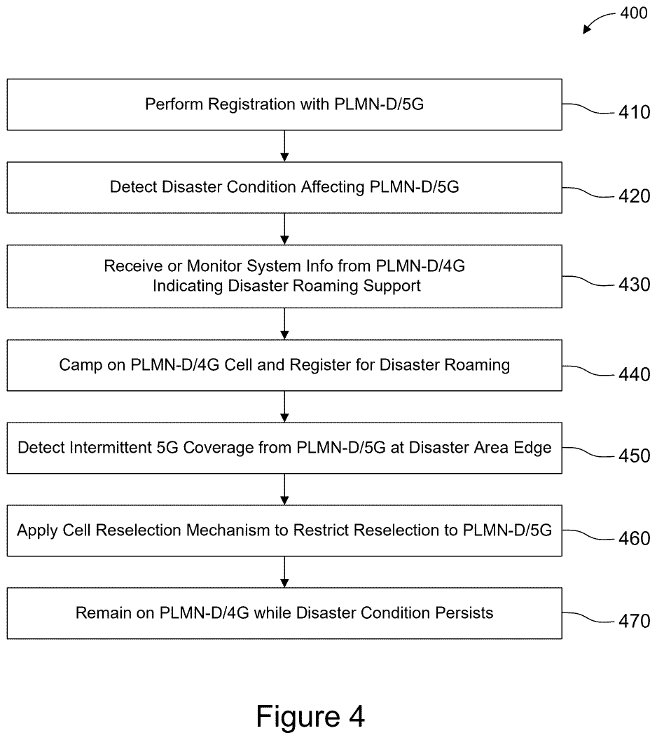

FIG. 4 shows an example WTRU based procedure 400 to manage mobility and service continuity during disaster conditions that impact 5G network coverage. At 410, the WTRU initially performs a registration procedure with a public land mobile network (PLMN-D) operating in a fifth-generation (5G) access network (PLMN-D/5G). Upon detection of a disaster condition affecting the 5G service, at 420, the WTRU transitions its behavior based on network broadcasts. At 430, the WTRU monitors or receives system information from a PLMN-D/4G cell indicating that it provides disaster roaming services for PLMN-D/5G. In response, the WTRU camps on the PLMN-D/4G cell and registers for disaster roaming services at 440. While moving near the edge of the disaster zone, the WTRU may intermittently detect coverage from PLMN-D/5G cells providing normal service, 450. To prevent frequent or unnecessary reselection that could lead to service disruption, the WTRU applies one or more reselection restriction mechanisms at 460, such as ignoring 5G system information, adjusting thresholds, or prioritizing the 4G cell. Finally, at 470, the WTRU remains camped on the 4G cell as long as the disaster condition persists, ensuring stable connectivity and a better user experience during recovery operations.

While the invention is described with reference to a 4G access network providing disaster roaming services for a 5G network, the principles and mechanisms disclosed herein are not limited to this specific configuration. The techniques may be equally applicable to other combinations of access technologies, including but not limited to 5G and 6G, 4G and 6G, or any future generation networks. More generally, the invention applies to any scenario in which multiple radio access technologies are operated under a common or coordinated PLMN and may be differentially impacted by disaster conditions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), comprising:
performing, by the WTRU, a registration procedure with a first public land mobile network (PLMN), the first PLMN operating in a fifth-generation (5G) access network (PLMN-D/5G);
detecting, by the WTRU, that the PLMN-D/5G is under disaster condition;
receiving or monitoring, by the WTRU, system information broadcast by a cell of a second PLMN operating in a fourth-generation (4G) access network (PLMN-D/4G) cell, the system information indicating that the PLMN-D/4G cell provides disaster roaming services and includes a list of PLMN IDs under disaster for which the PLMN-D/4G cell is providing disaster roaming;
camping, by the WTRU, on the PLMN-D/4G cell and registering for disaster roaming services with the second PLMN-D/4G; and
utilizing a cell reselection mechanism to restrict the WTRU from performing cell reselection to one or more cells of PLMN-D/5G while the disaster condition is ongoing.

2. The method of claim 1, wherein the detecting that the PLMN-D/5G is under disaster condition comprises at least one of: (a) receiving, from the PLMN-D/4G or another operational PLMN (PLMN-A), a broadcast indication of a disaster condition affecting PLMN-D/5G; (b) receiving, from PLMN-D/5G, a rejection message in response to the registration procedure, the rejection message including an indication of disaster conditions; or (c) receiving, from PLMN-A or another PLMN, broadcast information identifying one or more PLMN identifiers (PLMN IDs) that are under disaster conditions, wherein the list includes a PLMN ID of PLMN-D/5G.

3. The method of claim 1, wherein the cell reselection mechanism to restrict the WTRU comprises ignoring system information block 24 (SIB24) content broadcast by the PLMN-D/4G cell that identifies neighboring 5G cells.

4. The method of claim 3, wherein the WTRU is configured to not request SIB24 from the PLMN-D/4G cell upon receiving an indication of a disaster condition.

5. The method of claim 1, wherein the cell reselection mechanism to restrict the WTRU comprises assigning the highest reselection priority to the PLMN-D/4G cell, such that the PLMN-D/4G cell has a reselection priority higher than any neighboring 5G cell.

6. The method of claim 1, wherein the cell reselection mechanism to restrict the WTRU comprises overriding a default cell reselection timer value with an extended duration to delay reselection to a 5G cell unless predefined threshold conditions are met.

7. The method of claim 6, wherein the predefined threshold conditions include one or more of: (a) a reference signal received power (RSRP) of the 4G cell falls below a threshold, (b) the WTRU is engaged in critical uplink or downlink data transmission, or (c) system broadcast indicates safe transition conditions.

8. The method of claim 1, wherein the cell reselection mechanism to restrict the WTRU comprises skipping one or more frequency locations associated with synchronization signal blocks (SSBs) or ARFCNs corresponding to PLMN-D/5G cells during cell search.

9. The method of claim 8, wherein the skipped frequency locations are indicated via system information broadcast by the PLMN-D/4G cell, including at least one of system information block 1 (SIB1), system information block 15 (SIB15), or a new system information block (SIBx).

10. The method of claim 1, wherein the cell reselection mechanism to restrict the WTRU comprises applying alternative threshold or offset values for reselection metrics, including RSRP, RSRQ, or SINR values, based on the presence of a disaster-related indication.

11. The method of claim 10, wherein the WTRU switches from a first set of threshold values to a second, more restrictive set of threshold values upon receiving the disaster-related indication.

12. The method of claim 1, wherein the cell reselection mechanism to restrict the WTRU comprises receiving a cell barring indication in a master information block (MIB) or SIB1 of a PLMN-D/5G cell, and treating the 5G cell as barred for a duration of the disaster condition.

13. The method of claim 11, wherein the WTRU evaluates the cell barring status according to a configured system information modification periodicity.

14. The method of claim 1, wherein the cell reselection mechanism to restrict the WTRU comprises receiving a paging indication from the PLMN-D/4G cell or a cell of the first PLMN-D/5G, wherein the paging indication includes one or more updated reselection parameters that restrict reselection to first PLMN-D/5G during the disaster condition.

15. The method of claim 14, wherein the paging indication triggers the WTRU to request additional system information including reselection criteria such as updated threshold values, priority values, or timer durations.

16. The method of claim 1, further comprising initiating reselection to a cell of the first PLMN-D/5G upon detecting that the disaster condition has ended and receiving a corresponding broadcast or dedicated signal indicating that normal 5G service has resumed.

17. A wireless transmit/receive unit (WTRU) configured to operate within multiple public land mobile networks (PLMNs) during a disaster condition, the WTRU comprising:
a processor; and
a transceiver, wherein the processor and transceiver are configured to:
perform a registration procedure with a first public land mobile network (PLMN), the first PLMN operating in a fifth-generation (5G) access network (PLMN-D/5G);
detect that the PLMN-D/5G is under disaster condition;
receive or monitor, system information broadcast by a cell of a second PLMN operating in a fourth-generation (4G) access network (PLMN-D/4G) (PLMN-D/4G cell), the system information indicating that the PLMN-D/4G cell provides disaster roaming services and includes a list of PLMN IDs under disaster for which the PLMN-D/4G cell is providing disaster roaming;
camp on the PLMN-D/4G cell and registering for disaster roaming services with PLMN-D/4G; and
utilize a cell reselection mechanism to restrict the WTRU from performing cell reselection to one or more cells of PLMN-D/5G while the disaster condition is ongoing.

18. The WTRU of claim 17, wherein the cell reselection mechanism is configured to ignore system information block 24 (SIB24) content broadcast by the PLMN-D/4G cell that identifies neighboring 5G cells.

19. The WTRU of claim 17, wherein the cell reselection mechanism is configured to assign the highest reselection priority to the PLMN-D/4G cell, such that the PLMN-D/4G cell has a reselection priority higher than any neighboring 5G cell.

20. The WTRU of claim 17, wherein the cell reselection mechanism is configured to override a default cell reselection timer value with an extended duration to delay reselection to a 5G cell unless predefined threshold conditions are met.
